(19) United States
(12) Patent Application Publication
(10) Pub. No.: US 2024/0208230 A1
(43) Pub. Date: Jun. 27, 2024

(54) RECORDING APPARATUS AND CONTROL METHOD OF RECORDING APPARATUS

(71) Applicant: CANON KABUSHIKI KAISHA, Tokyo (JP)

(72) Inventor: SHUNYA SUNOUCHI, Tokyo (JP)

(21) Appl. No.: 18/390,982

(22) Filed: Dec. 20, 2023

(30) Foreign Application Priority Data
Dec. 26, 2022 (JP) 2022-207961

(51) Int. Cl. B41J 2/17; B41J 2/045; B41J 2/14; B41J 2/175

(52) U.S. Cl. CPC B41J 2/1721; B41J 2/04563; B41J 2/14153; B41J 2/17566; B41J 2002/17569

(57) ABSTRACT

A recording apparatus includes a discharge unit that causes a recording head to discharge liquid, a storing unit that stores the liquid discharged from the recording head, and a control unit that notifies a user not to start a discharge operation until a predetermined time has passed since a previous session of the discharge operation, when an amount of liquid discharged in the previous session of the discharge operation by the discharge unit is a first discharge amount, and not to notify the user in a case where the amount of liquid discharged in the previous session of the discharge operation by the discharge unit is a second discharge amount smaller than the first discharge amount.

### BACKGROUND

### Field

The present disclosure relates to a recording apparatus that performs recording by ejecting a liquid.

### Description of the Related Art

Inkjet printers are a typical example of a liquid ejecting recording apparatus. Some known inkjet printers are equipped with a waste liquid collection portion (waste ink collection portion) for collecting and holding recording liquid (ink) that was forcefully discharged from a recording head for the maintenance of the recording head. It is necessary to provide the waste liquid collection portion with a measure to prevent leakage of the waste liquid to the outside. Japanese Patent Application Publication No. 2008-62555 describes a configuration in which an ink discharge operation is performed at a time interval that is longer than the time required for waste ink to be absorbed in a waste ink absorber that is provided in the waste ink collection portion.

### SUMMARY

The present disclosure further advances conventional techniques by providing a technique that minimizes liquid leakage when collecting waste liquid.

According to an aspect of the present disclosure, a recording apparatus of the present disclosure includes a discharge unit configured to cause a recording head to discharge liquid, a storing unit configured to store the liquid discharged from the recording head, and a control unit configured to notify a user not to start a discharge operation until a predetermined time has passed since a previous session of the discharge operation, in a case where an amount of liquid discharged in the previous session of the discharge operation by the discharge unit is a first discharge amount, and configured not to notify the user in a case where the amount of liquid discharged in the previous session of the discharge operation by the discharge unit is a second discharge amount smaller than the first discharge amount.

According to another aspect of the present disclosure, a recording apparatus of the present invention includes a discharge unit configured to cause a recording head to discharge liquid, a storing unit configured to store the liquid discharged from the recording head, and a control unit configured to notify a user not to start a discharge operation until a predetermined time has passed since a previous session of the discharge operation, in a case where an amount of liquid to be discharged in a current session of the discharge operation by the discharge unit is a first discharge amount, and configured not to notify the user in a case where the amount of liquid to be discharged in the current session of the discharge operation by discharge unit is a second discharge amount smaller than the first discharge amount.

According to yet another aspect of the present disclosure, a method of controlling a recording apparatus, which includes a discharge unit configured to cause a recording head to discharge liquid, and a storing unit configured to store the liquid discharged from the recording head, the method includes notifying a user not to start a discharge operation until a predetermined time has passed since a previous session of the discharge operation, when an amount of liquid discharged in the previous session of the discharge operation by the discharge unit is a first discharge amount.

According to the present disclosure, liquid leakage when collecting waste liquid is minimized.

Further features of the present disclosure will become apparent from the following description of exemplary embodiments with reference to the attached drawings.

### BRIEF DESCRIPTION OF THE DRAWINGS

FIG. 1 is an external perspective view of a recording apparatus according to one embodiment of the present disclosure.

FIG. 2 is a perspective view illustrating internal structures of the recording apparatus according to one embodiment of the present disclosure.

FIG. 3A and FIG. 3B are diagrammatic views of the configuration of containers and the vicinity.

FIG. 4 is a diagrammatic cross-sectional view of a waste ink collection tank.

FIG. 5A and FIG. 5B are diagrammatic cross-sectional views illustrating how ink flows into the waste ink collection tank.

FIG. 6A and FIG. 6B are diagrammatic cross-sectional views illustrating how bubbling ink flows into the waste ink collection tank.

FIG. 7 is a flowchart of an ink discharge operation according to one embodiment of the present disclosure.

FIG. 8 is a flowchart of an ink discharge operation according to another embodiment of the present disclosure.

FIG. 9 is a block diagram of a control unit of the recording apparatus of FIG. 1.

### DESCRIPTION OF THE EMBODIMENTS

Embodiments will be hereinafter described in detail with reference to the accompanying drawings. It should be noted that the following embodiments are not intended to limit the disclosure according to the claims. While some features are described in the embodiments, not all of these features are necessarily essential for the disclosure, and these features may be combined as desired. Same or similar configurations in the accompanying drawings are given the same reference numerals and repetitive descriptions will be omitted.

### Embodiment 1

### Overview of Recording Apparatus

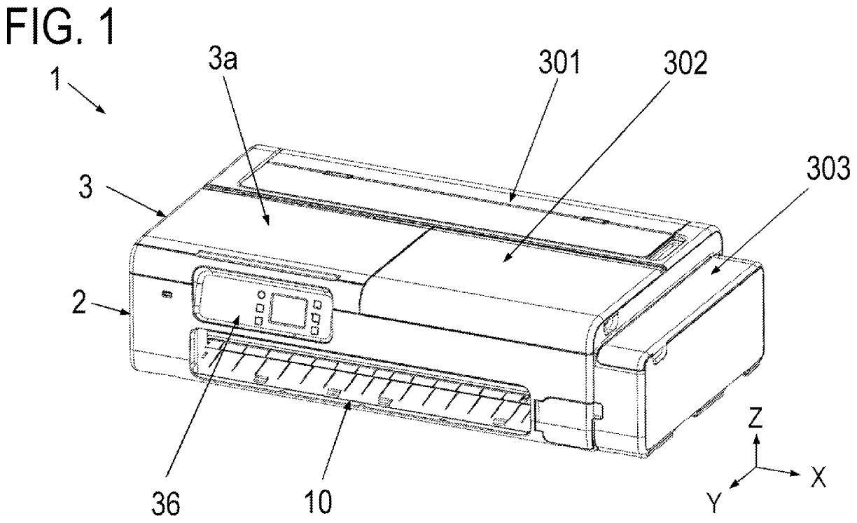

FIG. 1 is an external view of a recording apparatus 1 according to one embodiment of the present disclosure viewed from the front. The recording apparatus 1 in this embodiment is a liquid ejecting recording apparatus (inkjet printer) that performs recording on a recording medium by ejecting ink that is a recording liquid. In the drawing, arrows X and Y indicate horizontal directions orthogonal to each other, and arrow Z indicates an up and down direction (direction of gravity). The X direction is the widthwise direction (left and right direction) of the recording apparatus 1. The Y direction is the depth direction of the recording apparatus 1.

The term “recording” herein not only means formation of information with meaning such as letters or characters and figures but also broadly encompasses any formation of images, designs, and patterns on a recording medium including processing of the medium itself, whether they contain meaning or not and whether they are manifested such as to be visually perceptible to humans. While the “recording medium” in this embodiment is supposed to be sheet-like paper, the recording medium may be other materials such as fabric or plastic film.

The recording apparatus 1 has a flat rectangular parallelepiped shape as a whole and includes an apparatus main body 2 and a main body cover portion 3 composed of a plurality of covers. The main body cover portion 3 is provided such as to cover the apparatus main body 2 and forms a top part of the recording apparatus 1. The main body cover portion 3 of this embodiment includes a paper feed cover 301, an access cover 302 for allowing access to the apparatus interior for maintenance, and a tank access cover 303 that covers a part where ink is supplied to the tank in the apparatus. A reading unit (scanner unit) 3a that reads an image on an original is provided, and may entirely be moved with the access cover 302 when the cover is opened and closed for a maintenance operation of the interior of the apparatus. An exit portion 10 is formed on the front side of the recording apparatus 1 where the recording medium is expelled after the recording. An operation unit 36 is provided also on the front side of the recording apparatus 1 for receiving operations from an operator. The operation unit 36 includes a touchscreen display portion for allowing the operator to perform input operations, as well as for displaying information for the operator.

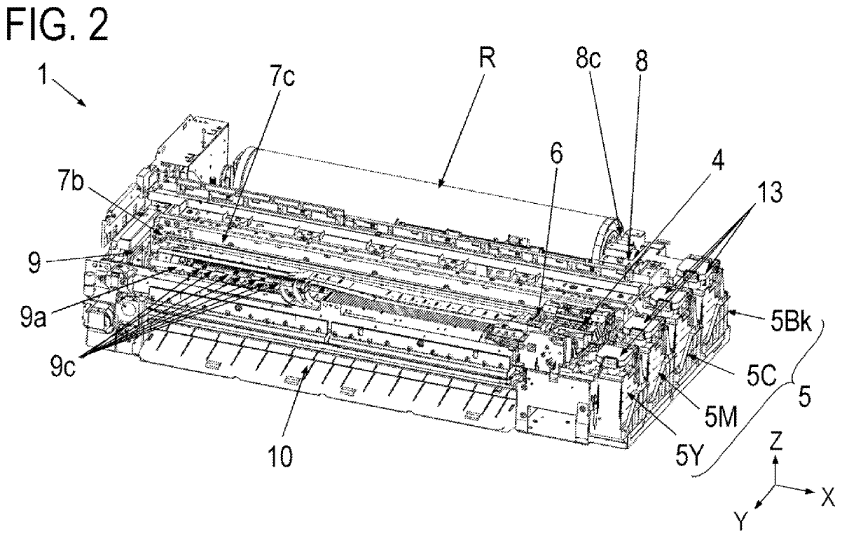

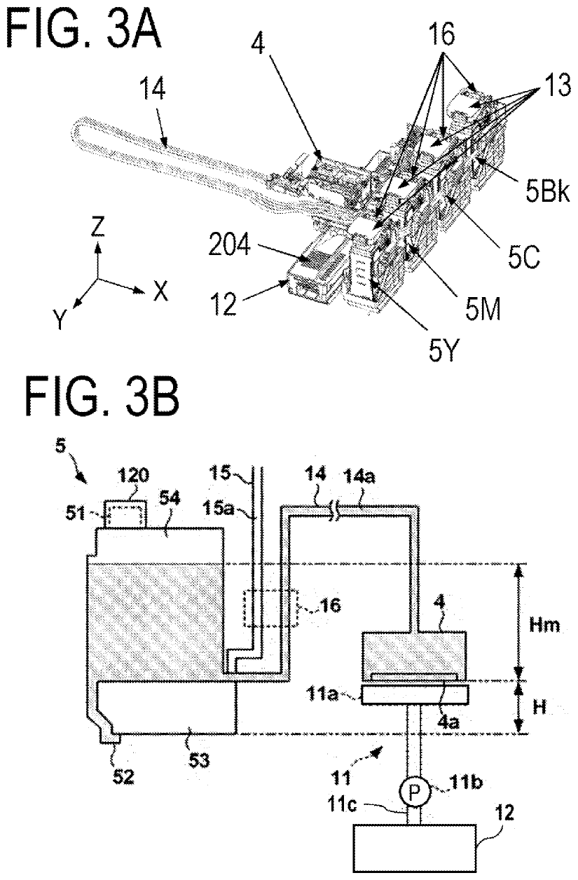

FIG. 2 is an illustrative diagram illustrating the internal structures of the recording apparatus 1. The recording apparatus 1 includes a recording head 4 that ejects ink. The recording head 4 in this embodiment performs recording by ejecting ink supplied from a container 5 on a recording medium. The recording head 4 includes an ejection surface 4a (see FIG. 3B) where a plurality of nozzles are formed for ejecting ink. Each nozzle is provided with a thermoelectric conversion element (heater), for example, which generates heat when power is supplied and creates a bubble in the ink, to use the bubble energy to eject the ink.

The recording head 4 is mounted on a carriage 6. The carriage 6 is reciprocated in the X direction (main scanning direction) by a drive unit that is not shown. The drive unit includes a drive pulley (not shown) and a driven pulley 7b spaced away from each other in the X direction, an endless belt 7c passed around these pulleys, and a carriage motor (not shown) that is the drive source for rotating the drive pulley. The carriage 6 is coupled to the endless belt 7c so that the carriage 6 is moved in the X direction by running the endless belt 7c. Ink is ejected from the recording head 4 onto the recording medium in the course of the travel of the carriage 6 so that an image is recorded on the recording medium. This operation is sometimes referred to as record scanning.

As described above, the recording apparatus 1 of this embodiment is a serial type inkjet recording apparatus with a recording head 4 mounted on a reciprocating carriage 6. Note, however, that the present disclosure is applicable to other types of recording apparatuses such as an inkjet recording apparatus with a full-width printhead provided with a plurality of nozzles that eject a liquid to a region spanning the width of the recording medium.

The recording apparatus 1 includes a feed unit 8 and a conveyance unit 9 that convey the recording medium. The feed unit 8 includes a roll set portion 8c that supplies a strip of continuous recording medium R from a roll, and a recording medium feed mechanism (not shown). The feed mechanism includes a feed roller (not shown), and a feed motor (not shown) that is a drive source for rotating the feed roller.

The conveyance unit 9 is a mechanism that conveys the recording medium fed from the feed unit 8 in the Y direction (sub-scanning direction). The conveyance unit 9 includes a conveyance roller 9a, and a conveyance motor (not shown) that is a drive source for rotating the conveyance roller 9a. A pinch roller 9c makes pressure contact with the conveyance roller 9a, and the recording medium is held in the nip portion between these rollers. The recording medium is conveyed intermittently to the recording head 4 by rotation of the conveyance roller 9a. A recording operation is performed by alternately repeating the conveyance operation of the recording medium by the conveyance unit 9 and the record scanning.

### Configurations of Ink Supply System and Waste Ink Collection System

In this embodiment, the container 5 is stationary and fixed to the recording apparatus 1 as illustrated in FIG. 2. When the remaining ink is low, the operator replenishes the ink to the container 5 without removing the container 5 from the recording apparatus 1. In this embodiment, four containers 5C, 5M, 5Y, and 5Bk are provided.

The containers 5C, 5M, 5Y, and 5Bk are provided in a quantity matching the number of colors of ink they contain, and arranged along the Y direction on the right side of the recording apparatus 1. Upper parts of the containers 5C to 5Bk are covered by the same tank cover part 13.

FIG. 3A is a perspective view of the peripheral structure of the containers 5C to 5Bk, illustrating only the containers 5C to 5Bk, valves 16, and recording head 4. The containers 5C to 5Bk are connected to the recording head 4 via supply tubes 14.

FIG. 3B is a diagrammatic view illustrating the structures of the container 5 and its vicinity. The containers 5C to 5Bk are basically configured as illustrated in FIG. 3B, with only some differences in the connecting position of the ink flow path and in the length of the supply tubes 14. The container 5 includes a storage portion 54 that contains the ink, a gas/liquid conversion portion 52, and a buffer chamber 53. The buffer chamber 53 is able to accommodate ink that is pushed out when the air inside of the storage portion 54 expands due to pressure fluctuations or temperature variations. A fill portion 51 is provided in an upper part of the container 5 for replenishment of the liquid (ink). The fill portion 51 is closed with a cap portion 120. When replenishing the ink, the operator removes the cap portion 120 from the fill portion 51, and performs the ink replenishing operation with the fill portion 51 being open. The cap portion 120 is provided for each container 5.

Passages 14a and 15a pass through inside of the container 5. The passage 14a communicates with the storage portion 54. The passage 14a is a liquid supply passage (ink supply passage) for supplying ink from the container 5 to the recording head 4, and formed by the supply tube 14 that is a flexible tube. The passage 15a communicates with the buffer chamber 53. The passage 15a is an air communication passage that communicates the interior of the container 5 with the atmosphere, and formed by an air communication tube 15 that is a flexible tube. The valves 16 open and close the passages 14a and 15a. In this embodiment, all the containers 5C to 5Bk are provided with their own valves 16.

The gas/liquid conversion portion 52 is positioned lower by height H than the ejection surface 4a of the recording head 4. Namely, a negative pressure is applied to the ejection surface 4a by the water head difference of the height H. This configuration can prevent the ink from leaking from the ejection surface 4a. The buffer chamber 53 is positioned in a lower part of the container 5. This configuration can prevent the ink from leaking from the air communication passage 15a.

For supplying ink to the recording head 4, the passages 14a and 15a both need to be opened during the recording operation. When replenishing ink to the container 5, on the other hand, the passages 14a and 15a both need to be closed. When replenishing ink, the ink level in the container 5 may become higher than the height of the ejection surface 4a of the recording head 4. If the passage 14a is open, a pressure will be applied to the ejection surface 4a by the water head difference of height Hm, which can cause ink leakage from the ejection surface 4a. While it is possible to design the container 5 such that the ink level inside of the container 5 will not become higher than the height of the ejection surface 4a of the recording head 4, it will impose limitations on the amount of ink that can be held in the container 5, and on the degree of design freedom in the Z direction of the recording apparatus 1. If the passage 15a is not closed, the replenished ink may flow into the buffer chamber 53. If this happens, the buffer chamber 53 may not be able to serve its purpose, which is to accommodate ink that is pushed out of the storage portion 54 due to pressure fluctuations or temperature variations.

A recovery unit 11 is a mechanism for maintaining the ink ejection performance of the recording head 4, and is disposed at one end of a movement range of the carriage 6. The recovery unit 11 includes a cap 11a that covers the ejection surface 4a of the recording head 4, and a pump 11b that sucks ink from the recording head 4 via the cap 11a. A mechanism (not shown) is provided to allow the cap 11a to move between the position where the cap covers the ejection surface 4a and a position spaced away from the ejection surface 4a. Capping the ejection surface 4a with the cap 11a can prevent the surface from becoming dry. By operating the pump 11b with the ejection surface 4a being capped with the cap 11a, thickened ink adhered to the recording head 4 can be removed, or the ink can be replenished to the passage 14a and recording head 4. When the recording operation is performed with the passage 14a and recording head 4 being filled with ink, the ink is supplied from the container 5 by an amount that was removed (ejected) from the recording head 4.

The recovery unit 11 further includes a waste ink collection tank 12 that collects the ink ejected or discharged from the ejection surface 4a. The waste ink collection tank 12 is connected to the pump 11b via a drain tube 11c. The ink is sucked by operating the pump 11b and collected to the waste ink collection tank 12 via the drain tube 11c.

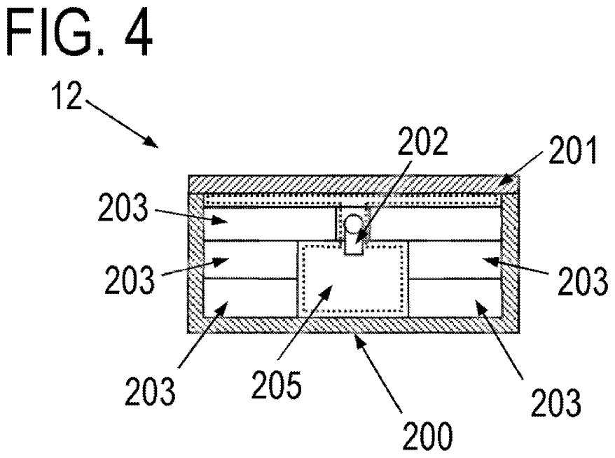

FIG. 4 is a diagrammatic cross-sectional view illustrating a waste ink inlet portion of the waste ink collection tank 12. The waste ink collection tank 12 forms a box-like tank container with a tank case 200 and a tank cover 201. Inside of the tank case 200 are provided a waste ink inlet 202 that is in communication with the drain tube 11c, and an ink absorber 203 for absorbing and holding the waste ink. The ink absorber 203 may for example be laminated paper or a porous member. Opening portions 204 (see FIG. 3A) are provided to the tank cover 201 for accelerating evaporation of the ink absorbed and held in the ink absorber 203. Near the waste ink inlet 202 is provided an ink holding space 205 for temporarily holding waste ink in the form of bubbles that can hardly be absorbed by the ink absorber 203. Namely, the waste ink collection tank 12 as an ink storing unit includes two container interior spaces, a first waste liquid holding space where the ink absorber 203 or liquid absorber is disposed, and a second waste liquid holding space where the ink absorber 203 is not disposed.

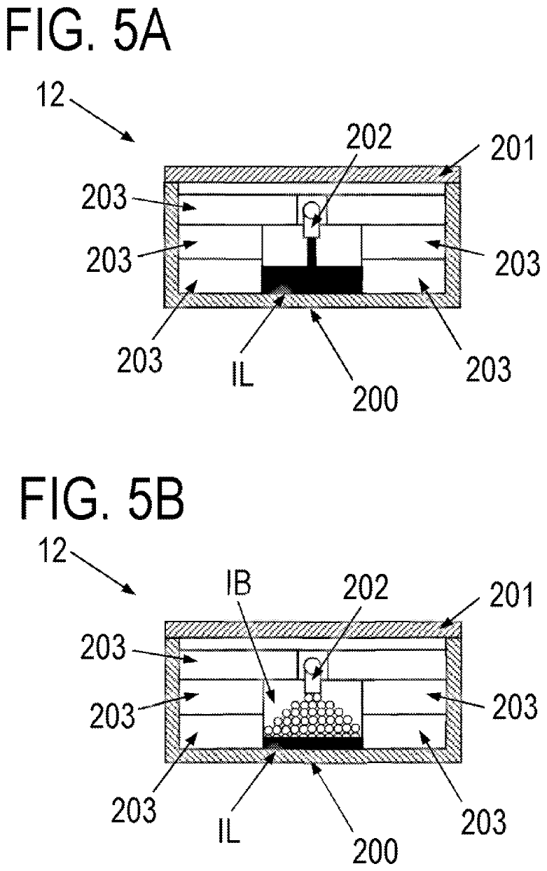

FIG. 5A and FIG. 5B are diagrammatic cross-sectional views illustrating how ink flows into the waste ink collection tank. Executing an ink discharge operation activates the pump 11b for sucking the ink from the recording head 4. As illustrated in FIG. 5A, when sucked, the waste ink IL in liquid form first flows into the ink holding space 205 from the waste ink inlet 202 of the waste ink collection tank 12 via the drain tube 11c. After that, as illustrated in FIG. 5B, bubbles of waste ink IB formed by mixing with the air in the drain tube 11c flow into the ink holding space 205 from the waste ink inlet 202. While the liquid waste ink IL is absorbed by the adjacent ink absorber 203, the bubbles of waste ink IB are hardly absorbed by the ink absorber 203 and remain in the ink holding space 205 for a while until they disappear.

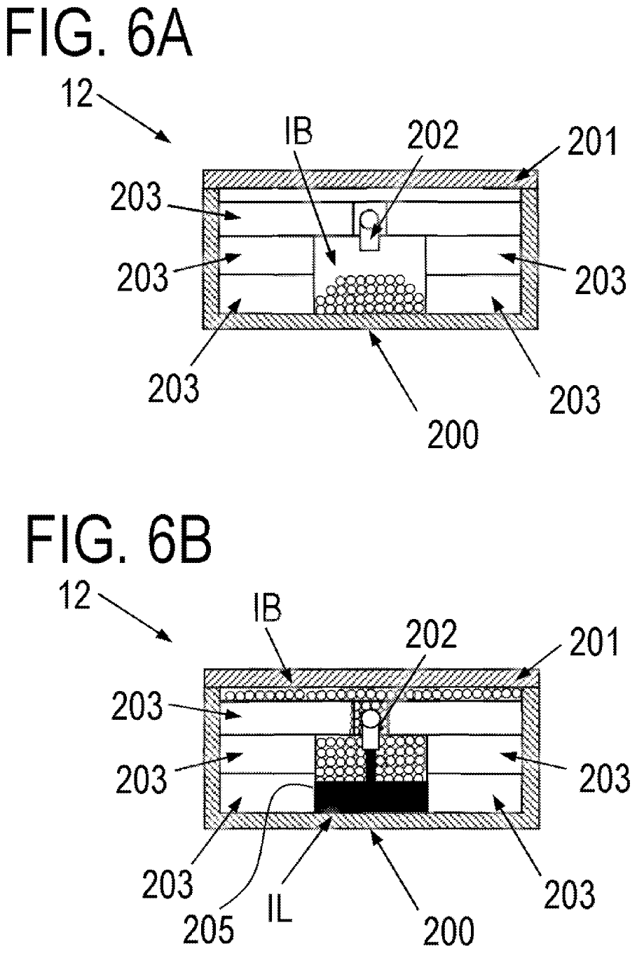

FIG. 6A is a diagrammatic cross-sectional view illustrating the bubbles of ink remaining in the waste ink collection tank. FIG. 6B is a diagrammatic cross-sectional view illustrating how the bubbles of ink remaining in the waste ink collection tank are pushed up by the liquid ink. When the ink discharge operation is performed again with bubbles of waste ink IB remaining in the ink holding space 205 as illustrated in FIG. 6A, the liquid waste ink IL flows in from the waste ink inlet 202. The inflow of liquid waste ink IL pushes the bubbles of waste ink IB upward in the ink holding space 205, as illustrated in FIG. 6B. Depending on the amount of remaining bubbles of waste ink IB and the amount of inflow of liquid waste ink IL, there is a possibility that the waste ink leaks out from the joint between the tank case 200 and the tank cover 201 or from the opening portions 204 of the tank cover 201. Accordingly, a wait time is provided for allowing the bubbles of waste ink IB to disappear between ink discharge operations to prevent such leakage of waste ink to the outside of the waste ink collection tank 12.

An overview of the ink discharge control in this embodiment will be described.

The ink discharge control in this embodiment is generally the control of the wait time before the start of the current ink discharge operation based on the expected amount of discharge in the ink discharge operation about to be performed, the amount of discharge in the previous ink discharge operation, and the time (end time) when the previous discharge operation was performed.

More specifically, the ink discharge control in this embodiment can be understood as the control for making the interval between the previous ink discharge operation and the current ink discharge operation longer than a predetermined time, for example, when the amount of discharge in the previous ink discharge operation is a first discharge amount which is larger than a predetermined discharge amount. In this case, the predetermined time can be determined on the basis of a time required for the waste ink collection tank 12 to be restored, after the end of the previous ink discharge operation, to a condition capable of storing an amount of ink to be discharged in the current ink discharge operation. The predetermined discharge amount in this case can be the amount of ink discharged in the previous ink discharge operation that allows the interval between the previous ink discharge operation and the current ink discharge operation to be within the predetermined time. In other words, the predetermined discharge amount can be a threshold discharge amount for the previous ink discharge operation that allows the waste ink collection tank 12 to be restored to a certain condition within the predetermined time. On the other hand, when the amount of discharge in the previous ink discharge operation is a second discharge amount which is smaller than the first discharge amount and less than or equal to the predetermined discharge amount, the control of the wait time is not necessary.

Alternatively, the ink discharge control in this embodiment can be understood as the control for making the interval between the previous ink discharge operation and the current ink discharge operation longer than a predetermined time, for example, when the amount of ink to be discharged in the current ink discharge operation is going to be the first discharge amount which is larger than a predetermined discharge amount. In this case, the predetermined discharge amount can be an amount of ink to be discharged that can be stored in the waste ink collection tank 12 at the current time (when the current ink discharge operation is about to be performed). The predetermined time can be rephrased as a time required for the waste ink collection tank 12 to recover the ink storage capacity that exceeds the expected amount of discharge in the current ink discharge operation. On the other hand, when the amount of discharge in the current ink discharge operation is going to be the second discharge amount which is smaller than the first discharge amount and less than or equal to the predetermined discharge amount, the control of the wait time is not necessary.

The waste ink collection tank 12 recovers the ink storage capacity with time, as the ink bubbles generated in the waste ink collection tank 12 during the previous ink discharge operation decrease, for example. Accordingly, the ink storage capacity of the waste ink collection tank 12 at the current time can be obtained on the basis of the maximum ink storage capacity of the waste ink collection tank 12, the amount of bubbles at the end of the previous ink discharge operation, and the amount of bubbles that disappear per unit time.

The amount of bubbles generated during the previous ink discharge operation affects the timing of beginning the current ink discharge operation, and therefore the discharge amount in the previous ink discharge operation provides an index to determine the start time of the current ink discharge operation. The amount of bubbles at the end of the previous ink discharge operation can be obtained from this discharge amount in the previous ink discharge operation. On the basis of the amount of bubbles at the end of the previous ink discharge operation, the amount of bubbles that disappear per unit time that is empirically obtained, and the time passed since the end of the previous ink discharge operation, the currently available capacity (storage capacity) of the waste ink collection tank 12 can be detected (estimated).

When the discharge amount in the current ink discharge operation is going to be larger than this available capacity of the waste ink collection tank 12 thus deduced from the discharge amount in the previous ink discharge operation, the start time of the current ink discharge operation may be delayed until the latter exceeds the former. Namely, the available capacity described above is the reference value (threshold) for the discharge amount in the previous ink discharge operation.

In the case where a predetermined ink discharge operation is repeated a number of times, for example, there may be provided a predetermined time (interval) as a reference value between previous and current sessions of the ink discharge operation. In such a case, a discharge amount in the previous session of ink discharge operation that allows the current session to be performed after an interval that does not exceed the predetermined time can be used as the threshold for switching the control. When the actual discharge amount in the previous session of ink discharge operation exceeds this predetermined threshold discharge amount, the start time of the current session of ink discharge operation is delayed.

The amount of ink to be discharged in the current discharge operation also affects the timing of beginning the current ink discharge operation in relation to the currently available capacity of the waste ink collection tank 12, and therefore provides an index to determine the start time of the current ink discharge operation. When the discharge amount of the current ink discharge operation is going to be larger than the currently detected (estimated) available capacity (storage capacity) of the waste ink collection tank 12, the start time of the current ink discharge operation is delayed. Namely, the available capacity described above is the reference value (threshold) for the discharge amount in the current ink discharge operation.

Another approach in determining the start time is to draw on the interval between previous and current sessions of an ink discharge operation. According to this approach, a predetermined time is set as a reference value for the interval mentioned above, and the actual interval obtained from the actual discharge amount in the previous ink discharge operation and the actual discharge amount in the current ink discharge operation (time required for the recovery of the waste ink collection tank 12) is compared with this predetermined time. When the actual interval is longer than the predetermined time, the apparatus is controlled to wait for the waste ink collection tank 12 to recover before beginning the current ink discharge operation.

Some of the information used for obtaining an ink storage amount, i.e., at least the time (end time) of the ink discharge operation and the amount of bubbles at the end of the ink discharge operation, should preferably be stored in a memory unit such as memory chip provided to the waste ink collection tank 12. The configuration wherein such information is obtained from a memory chip provided to the waste ink collection tank 12 allows detection of whether or not the waste ink collection tank 12 has been replaced.

It should be noted that generation of ink bubbles described in this embodiment is only one example of specific conditions for holding the immediate execution of the current ink discharge operation. When there are conditions other than generation of bubbles, the same effects as in this embodiment can be obtained by setting a suitable wait time required for such conditions to be resolved.

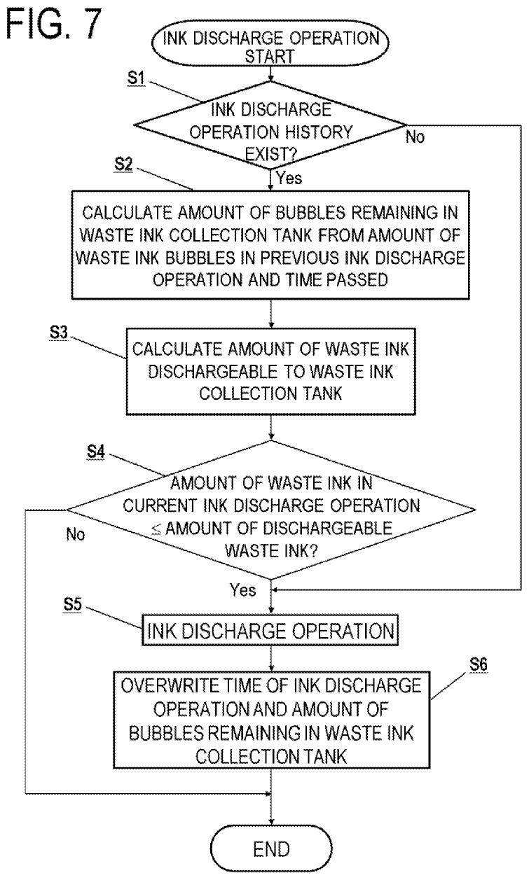

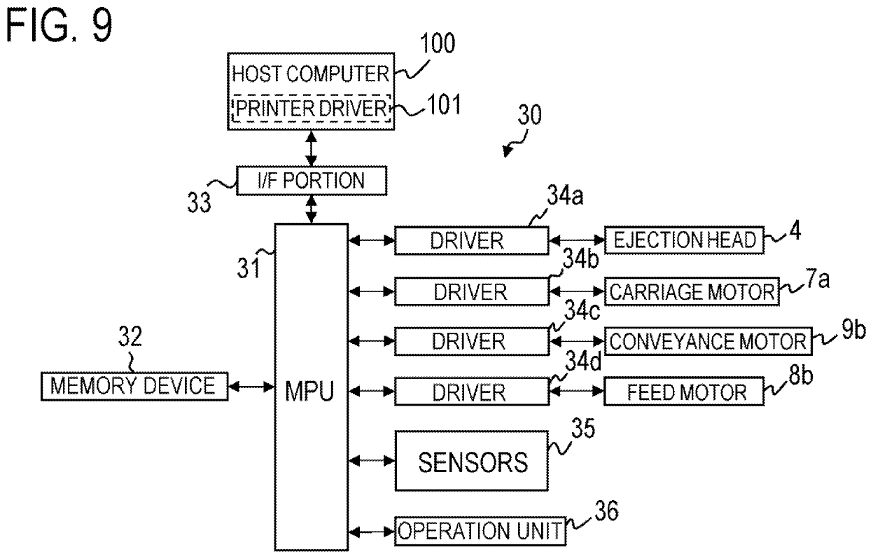

The ink discharge control will be described in accordance with the flowchart of FIG. 7. This control is executed proactively by a control unit 30 (FIG. 9) as a control portion as part of various maintenance operations (recovery operations) during the time when the recording operation to the recording medium is not performed.

When an ink discharge operation is initiated, the control unit 30 first checks if there is an ink discharge operation history (step S1).

When there is no ink discharge operation history, the ink discharge operation is executed (step S5), after which the time when the ink discharge operation was performed and the amount of bubbles generated in the waste ink collection tank 12 are stored in an information recording portion (not shown) provided to the waste ink collection tank 12 (step S6).

When there is an ink discharge operation history, the amount of remaining bubbles in the waste ink collection tank 12 at the current time is calculated by subtracting the amount of bubbles that have disappeared during the time passed since the previous ink discharge operation until the current time from the amount of remaining bubbles in the waste ink collection tank 12 after the execution of the previous ink discharge operation (step S2). The amount of remaining bubbles may be calculated (estimated) by the following formula:
“Amount of bubbles generated by a predetermined recovery operation”−“Amount of bubbles that disappear per unit time”×“Time passed”. The amount of bubbles generated in each of various recovery operations and the amount of bubbles that disappear per unit time can be obtained in advance through tests using actual machines for example, and stored in the memory portion of the main body.

The amount of bubbles generated in each recovery operation correlates with the amount of waste ink (waste liquid) discharged to the waste ink collection tank 12 when the ink discharge operation was carried out in each recovery operation. The amount of waste ink can be estimated in accordance with the apparatus specifications and the type of recovery operation. For example, the recovered amount of ink that can be sucked (i.e., waste ink amount) when the ink tank is replaced during printing may be 1 g, and the recovered amount of ink that can be sucked during printing may be 0.2 g per 100 sheets each. The correlations between these amounts of waste ink and the amounts of bubbles generated are obtained in advance through experiments.

In this process, the amount of bubbles that disappear per unit time may be corrected on the basis of a temperature inside of the recording apparatus detected by a temperature sensor (not shown) provided in the recording apparatus 1 as temperature detection unit. A low-temperature environment is disadvantageous for bubbles to disappear and it tends to take a longer time for the generated bubbles to disappear completely. Therefore, the amount of bubbles that disappear per unit time may be corrected to a smaller value, for example, in a predetermined low-temperature environment.

The amount of waste ink that can be discharged to the waste ink collection tank 12 is calculated from the volume (capacity) of the ink holding space 205 and the amount of remaining bubbles calculated at step S2 (step S3). Here, the amount of remaining bubbles calculated at step S2 is the amount of remaining bubbles in the ink holding space 205 at the current time. The amount of waste ink that can be discharged to the waste ink collection tank 12 is the amount of space available for collecting waste ink in the waste ink collection tank 12 at the current time. The volume (capacity) of the ink holding space 205 corresponds to a maximum volume of the space available for accommodating bubbles of waste ink IB in the waste ink collection tank 12. The amount of waste ink expected to be discharged in the ink discharge operation about to be performed, and the amount of waste ink that can be discharged (collected) at the current time, are compared for determination (step S4).

When the amount of waste ink expected to be discharged is not more than the amount of waste ink that can be discharged (collected), the ink discharge operation is executed (step S5). The time when the ink discharge operation was performed and the amount of bubbles remaining in the waste ink collection tank 12 stored in the information recording portion (not shown) provided to the waste ink collection tank 12 are overwritten (step S6). The amount of bubbles remaining in the waste ink collection tank 12 stored at this time is the sum of the amount of bubbles of waste ink generated in the ink discharge operation that was performed this time, and the amount of remaining bubbles generated before that.

On the other hand, when the amount of waste ink expected to be discharged exceeds the amount of waste ink that can be discharged, the ink discharge operation is not executed and the operation is ended. At this time, it is preferable to output visual information on notification unit such as the touchscreen of the operation unit 36, for example, a message such as “Ink discharge currently not executable. Try again after xx minutes”, or “Replace waste ink collection tank to execute ink discharge”, to assist the user who is trying to carry out the ink discharge operation. For example, when cleaning operations, which produce the largest amount of waste ink, are to be performed in succession, and if it takes 60 minutes for all the bubbles generated in one cleaning operation to disappear in a low-temperature environment that is disadvantageous for the bubbles to disappear, then “60 minutes” is displayed as the wait time before the next cleaning operation. Alternatively, the user may be prompted to select whether or not the ink discharge operation is to be canceled by a message such as “Ink discharge executable after xx minutes. Cancel ink discharge?” When the ink discharge operation is not canceled, the operation may be executed automatically after xx minutes have passed. Not to mention, the assistance given to the user is not limited to this configuration. A message may be displayed on the screen of a mobile terminal or other devices, or may be given in the form of a voice or sound.

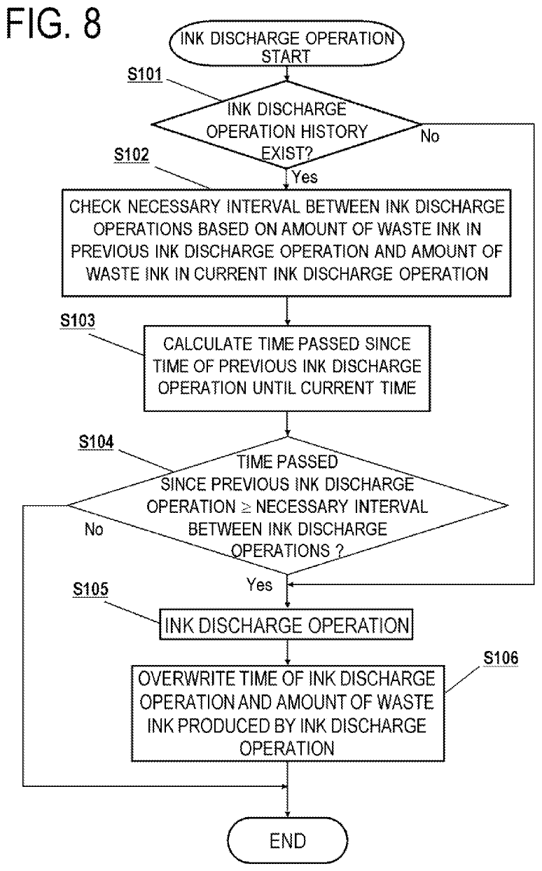

FIG. 8 is a flowchart illustrating another embodiment of the ink discharge control. The ink discharge control according to the present disclosure may be executed according to the flowchart shown in FIG. 8. Some of the particulars common to both flowcharts of FIG. 8 and FIG. 7 will not be described again. Any matters that are not specifically described here with reference to the flowchart of FIG. 8 should be understood as the same as those of FIG. 7.

When the ink discharge operation is initiated, the control unit 30 first checks if there is an ink discharge operation history (step S101).

When there is no ink discharge operation history, the ink discharge operation is performed (step S105). The time when the ink discharge operation was performed and the amount of waste ink discharged in the ink discharge operation stored in the information recording unit (not shown) provided to the waste ink collection tank 12 are overwritten (step S106).

When there is an ink discharge operation history, a necessary time interval between ink discharge operations is checked on the basis of the amount of waste ink in the previous ink discharge operation and the amount of waste ink in the current ink discharge operation (step S102). The necessary time interval between ink discharge operations in this case may be a fixed value in accordance with the amount of waste ink produced in a predetermined type of ink discharge operation.

Next, the time passed since the time of the previous ink discharge operation until the current time is calculated (step S103), and the time passed since the previous ink discharge operation and the necessary time interval between ink discharge operations are compared for determination (step S104).

When the time passed since the previous ink discharge operation is longer than the necessary time interval between ink discharge operations, the ink discharge operation is executed (step S105). The time when the ink discharge operation was performed and the amount of waste ink in the current ink discharge operation stored in the information recording unit (not shown) provided to the waste ink collection tank 12 are overwritten (step S106).

When the time passed since the previous ink discharge operation is shorter than the necessary time interval between ink discharge operations, the ink discharge operation is not executed and the operation is ended. At this time, it is preferable to output visual information on the touchscreen of the operation unit 36, for example a message such as “Ink discharge currently not executable. Try again after xx minutes”, or “Replace waste ink collection tank to execute ink discharge”, to assist the user who is trying to carry out the ink discharge operation. Alternatively, the user may be prompted to select whether or not the ink discharge operation is to be canceled by a message such as “Ink discharge executable after xx minutes. Cancel ink discharge?” When the ink discharge operation is not canceled, the operation may be executed automatically after xx minutes have passed. Not to mention, the assistance given to the user is not limited to this configuration. A message may be displayed on the screen of a mobile terminal or other devices, or may be given in the form of a voice or sound.

The wait time before the start of the current ink discharge operation may be set such that the current ink discharge operation is executed only after the bubbles have completely disappeared. Alternatively, the wait time may be set such that the current ink discharge operation is started when the bubbles have disappeared, not completely but to some extent, i.e., when the ink holding space 205 has begun to have some capacity.

### Control Unit

FIG. 9 is a block diagram of the control unit 30 of the recording apparatus 1. MPU 31 is a processor that controls various operations of the recording apparatus 1 and processing of data. The MPU 31 controls the entire recording apparatus 1 by executing a program stored in a memory device 32. The memory device 32 is configured by a ROM or RAM, for example. In addition to the program executed by the MPU 31, the memory device 32 stores various pieces of data necessary for the processing, such as the data received from a host computer 100.

The MPU 31 controls the recording head 4 via a driver 34a. The MPU 31 controls the carriage motor 7a via a driver 34b. The MPU 31 also controls the conveyance motor 9b and feed motor 8b via drivers 34c and 34d.

The MPU 31 also performs control operations by acquiring detection results of a group of various sensors 35 provided in the recording apparatus 1. The group of sensors 35 includes a temperature sensor provided inside of the recording apparatus 1 described above. The MPU 31 also executes display control of the display portion in the operation unit 36, and receives operations performed by the operator to the operation unit 36.

The host computer 100 is a personal computer or mobile terminal (such as a smartphone or tablet terminal) the operator uses, for example. A printer driver 101 is installed in the host computer 100 for performing communications between the host computer 100 and the recording apparatus 1. The recording apparatus 1 includes an interface portion 33. The communications between the host computer 100 and the MPU 31 are performed via the interface portion 33. When an instruction to execute a recording operation is input to the host computer 100 by the operator, for example, the printer driver 101 provides the image data to be recorded and recording settings (such as the quality of the image to be recorded) to the recording apparatus 1 and instructs execution of the recording operation.

The present disclosure is not limited to the embodiments described above and can be changed and modified in various ways without departing from the spirit and scope of the disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-207961, filed on Dec. 26, 2022, which is hereby incorporated by reference herein in its entirety.

What is claimed is:

1. A recording apparatus comprising:
a discharge unit configured to cause a recording head to discharge liquid;
a storing unit configured to store the liquid discharged from the recording head; and
a control unit configured to notify a user not to start a discharge operation until a predetermined time has passed since a previous session of the discharge operation, in a case where an amount of liquid discharged in the previous session of the discharge operation by the discharge unit is a first discharge amount, and configured not to notify the user in a case where the amount of liquid discharged in the previous session of the discharge operation by the discharge unit is a second discharge amount smaller than the first discharge amount.

2. The recording apparatus according to claim 1,
wherein the second discharge amount is an amount of liquid discharged in the previous session of the discharge operation that allows a time required for the storing unit to be restored to a condition capable of storing liquid to be discharged in a current session of the discharge operation after completion of the previous session of the discharge operation to be within the predetermined time.

3. A recording apparatus comprising:
a discharge unit configured to cause a recording head to discharge liquid;
a storing unit configured to store the liquid discharged from the recording head; and
a control unit configured to notify a user not to start a discharge operation until a predetermined time has passed since a previous session of the discharge operation, in a case where an amount of liquid to be discharged in a current session of the discharge operation by the discharge unit is a first discharge amount, and configured not to notify the user in a case where the amount of liquid to be discharged in the current session of the discharge operation by discharge unit is a second discharge amount smaller than the first discharge amount.

4. The recording apparatus according to claim 3,
wherein the second discharge amount is an amount of liquid to be discharged that can be stored in the storing unit at a time in a case where the current session of the discharge operation is executed.

5. The recording apparatus according to claim 1,
wherein the predetermined time is a time required for the storing unit to be restored to a condition capable of storing liquid discharged in the discharge operation, in a case where an amount of liquid discharged in the discharge operation is the first discharge amount.

6. The recording apparatus according to claim 5,
wherein the predetermined time is a time required for a storage capacity of liquid in the storing unit to exceed the amount of liquid to be discharged in a current session of the discharge operation.

7. The recording apparatus according to claim 6,
wherein the storage capacity recovers with time as bubbles of liquid generated by the previous session of the discharge operation in the storing unit reduce.

8. The recording apparatus according to claim 6,
wherein the storage capacity is obtained on the basis of:
the storage capacity of the storing unit;
an amount of bubbles of liquid generated by the previous session of the discharge operation in the storing unit at an end time of the discharge operation;
an amount of bubbles that disappear per unit time; and
a time between the end time of the previous session of the discharge operation and a current time.

9. The recording apparatus according to claim 8,
wherein the storing unit includes a memory unit that stores the end time and the amount of bubbles at the end time, and
wherein the control unit obtains the storage capacity using the end time and the amount of bubbles stored in the memory unit.

10. The recording apparatus according to claim 8,
further comprising a temperature sensor that detects a temperature inside of the recording apparatus,
wherein the control unit corrects the amount of bubbles that disappear on the basis of a detected temperature of the temperature sensor.

11. The recording apparatus according to claim 5,
wherein the storing unit comprises:
a container for storing liquid; and
a liquid absorber disposed inside of the container,
wherein the container comprises:
a first waste liquid holding space in which the liquid absorber is disposed; and
a second waste liquid holding space in which the liquid absorber is not disposed;
wherein the predetermined time is a time required for a liquid storage capacity of the second waste liquid holding space to exceed the amount of liquid to be discharged in a current session of the discharge operation.

12. The recording apparatus according to claim 1,
wherein the control unit controls the discharge unit to keep the discharge unit from starting a current session of the discharge operation until the predetermined time has passed.

13. The recording apparatus according to claim 1,
further comprising a notification unit that provides a notification to the user.

14. The recording apparatus according to claim 3,
wherein the control unit controls the discharge unit to keep the discharge unit from starting the current session of the discharge operation until the predetermined time has passed.

15. The recording apparatus according to claim 3,
further comprising a notification unit that provides a notification to the user.

16. A method of controlling a recording apparatus that comprises a discharge unit configured to cause a recording head to discharge liquid, and a storing unit configured to store the liquid discharged from the recording head, the method comprising:
notifying a user not to start a discharge operation until a predetermined time has passed since a previous session of the discharge operation, in a case where an amount of liquid discharged in the previous session of the discharge operation by the discharge unit is a first discharge amount.
